(19) United States
(12) Patent Application Publication
(10) Pub. No.: US 2021/0158606 A1
(43) Pub. Date: May 27, 2021

(54) APPARATUS AND METHOD FOR GENERATING THREE-DIMENSIONAL MODEL

(71) Applicant: ELECTRONICS AND TELECOMMUNICATIONS RESEARCH INSTITUTE, Daejeon (KR)

(72) Inventors: Seung-Wook LEE, Daejeon (KR); Ki-Nam KIM, Daejeon (KR); Tae-Joon KIM, Sejong-si (KR); Seung-Uk YOON, Daejeon (KR); Seong-Jae LIM, Daejeon (KR); Bon-Woo HWANG, Daejeon (KR); Chang-Joon PARK, Daejeon (KR)

(21) Appl. No.: 16/950,457

(22) Filed: Nov. 17, 2020

(30) Foreign Application Priority Data
Nov. 27, 2019 (KR) 10-2019-0154737

(51) Int. Cl. G06T 15/20; G06T 17/00

(52) U.S. Cl. CPC G06T 15/205; G06T 17/00

(57) ABSTRACT

Disclosed herein are an apparatus and method for generating a 3D model. The apparatus for generating a 3D model includes one or more processors, and an execution memory for storing at least one program that is executed by the one or more processors, wherein the at least one program is configured to receive two-dimensional (2D) original image layers for respective viewpoints, and generate pieces of 2D original image information for respective objects by performing original image alignment on the 2D original image layers for respective viewpoints for each predefined object type, generate 3D model layers for respective objects from the pieces of 2D original image information for respective objects using multiple learning models corresponding to the predefined object types, and generate a 3D model by synthesizing the 3D model layers for respective objects.

### CROSS REFERENCE TO RELATED APPLICATION

This application claims the benefit of Korean Patent Application No. 10-2019-0154737, filed Nov. 27, 2019, which is hereby incorporated by reference in its entirety into this application.

### BACKGROUND OF THE INVENTION

### 1. Technical Field

The present invention relates generally to artificial intelligence technology and three-dimensional (3D) object reconstruction and, more particularly, to technology for generating a 3D model from a two-dimensional (2D) image using artificial intelligence technology.

### 2. Description of the Related Art

Demand for generation of 3D objects, which are used in industrial sites and are complicatedly configured, from 2D images has increased. For this operation, among methods for generating a 3D object using artificial intelligence, there is a method for generating a 3D model from a 2D image. However, in this case, it is not easy to provide a 3D model having a complicated form using an original image implemented as a single image in most cases.

Meanwhile, Korean Patent Application Publication No. 10-2009-0072263 discloses technology entitled “3D image generation method and apparatus using hierarchical 3D image model, image recognition and feature point extraction method using the same, and recording medium storing program for performing the method thereof”. This patent discloses a method and apparatus which generate a 3D face image in which 3D features can be reflected from a 2D face image through hierarchical fitting, and utilize the results of the fitting for facial feature point extraction and face recognition.

### SUMMARY OF THE INVENTION

Accordingly, the present invention has been made keeping in mind the above problems occurring in the prior art, and an object of the present invention is to generate a 3D model, which is complicatedly configured, based on various original images, which cannot be provided by conventional technology.

Another object of the present invention is to accurately provide relative locations between objects and additional information of the objects when reconstructing a 3D model from a 2D image.

In accordance with an aspect of the present invention to accomplish the above object, there is provided an apparatus for generating a three-dimensional (3D) model, including one or more processors and an execution memory for storing at least one program that is executed by the one or more processors, wherein the at least one program is configured to receive two-dimensional (2D) original image layers for respective viewpoints, and generate pieces of 2D original image information for respective objects by performing original image alignment on the 2D original image layers for respective viewpoints for each predefined object type, generate 3D model layers for respective objects from the pieces of 2D original image information for respective objects using multiple learning models corresponding to the predefined object types, and generate a 3D model by synthesizing the 3D model layers for respective objects.

The at least one program may be configured to generate the pieces of 2D original image information for respective objects by performing the original image alignment on the 2D original image layers for respective viewpoints so that, depending on the predefined object types, multiple layers for respective viewpoints are included in at least one object type, wherein the 2D original image layers for respective viewpoints include multiple layers for respective object types for at least one viewpoint.

The at least one program may be configured to generate calibration information corresponding to relative location relationships between the multiple layers for respective object types.

The at least one program may be configured to generate the 3D model in consideration of the relative location relationships between the 3D model layers for respective objects using the calibration information.

The at least one program may be configured to transform an appearance of the 3D model by baking the 3D model using predefined displacement map information of the multiple layers for respective object types.

In accordance with an aspect of the present invention to accomplish the above object, there is provided a method for generating a 3D model using a 3D model generation apparatus, the method including receiving two-dimensional (2D) original image layers for respective viewpoints, and generating pieces of 2D original image information for respective objects by performing original image alignment on the 2D original image layers for respective viewpoints for each predefined object type, generating 3D model layers for respective objects from the pieces of 2D original image information for respective objects using multiple learning models corresponding to the predefined object types, and generating a 3D model by synthesizing the 3D model layers for respective objects.

Generating the pieces of 2D original image information for respective objects may be configured to generate the pieces of 2D original image information for respective objects by performing the original image alignment on the 2D original image layers for respective viewpoints so that, depending on the predefined object types, multiple layers for respective viewpoints are included in at least one object type, wherein the 2D original image layers for respective viewpoints include multiple layers for respective object types for at least one viewpoint.

Generating the pieces of 2D original image information for respective objects may be configured to generate calibration information corresponding to relative location relationships between the multiple layers for respective object types.

Generating the 3D model may be configured to generate the 3D model in consideration of the relative location relationships between the 3D model layers for respective objects using the calibration information.

Generating the 3D model may be configured to transform an appearance of the 3D model by baking the 3D model using predefined displacement map information of the multiple layers for respective object types.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an apparatus for generating a 3D model according to an embodiment of the present invention;

FIG. 2 is a diagram illustrating 2D original image layers for respective viewpoints produced in a multi-layer form according to an embodiment of the present invention;

FIG. 3 is a diagram illustrating a procedure for aligning original images in 2D original image layers for respective viewpoints according to an embodiment of the present invention;

FIG. 4 is a flow diagram illustrating a procedure for generating and synthesizing 3D model layers using a learning model according to an embodiment of the present invention;

FIG. 5 is an operation flowchart illustrating a method for generating a 3D model according to an embodiment of the present invention; and

FIG. 6 is a diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. Each of the terms “ . . . unit”, “. . . device” or “module” described in the specification means a unit for processing at least one function or operation, and may be implemented by hardware, software or a combination of hardware and software.

Hereinafter, preferred embodiments of the present invention will be described in detail with reference to the attached drawings.

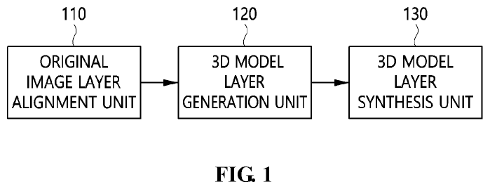

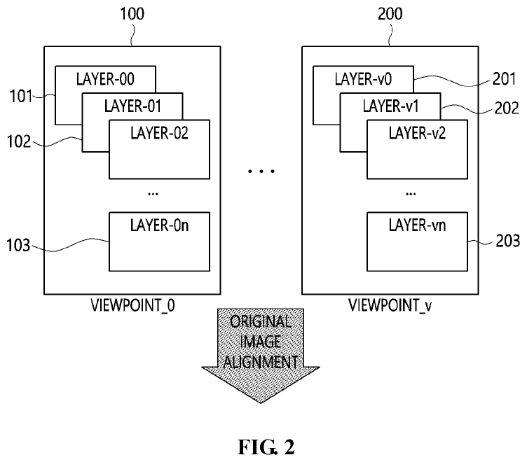

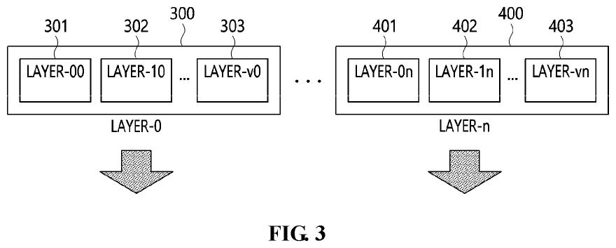

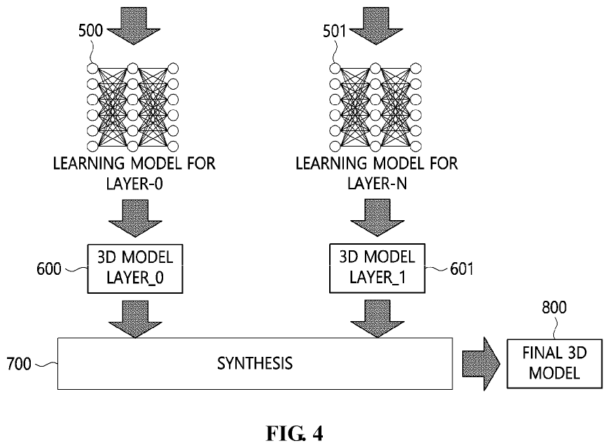

FIG. 1 is a block diagram illustrating an apparatus for generating a 3D model according to an embodiment of the present invention, FIG. 2 is a diagram illustrating 2D original image layers for respective viewpoints produced in a multi-layer form according to an embodiment of the present invention, FIG. 3 is a diagram illustrating a procedure for aligning original images in 2D original image layers for respective viewpoints according to an embodiment of the present invention, and FIG. 4 is a flow diagram illustrating a procedure for generating and synthesizing 3D model layers using a learning model according to an embodiment of the present invention.

Referring to FIG. 1, an apparatus for generating a 3D model (hereinafter also referred to as a “3D model generation apparatus”) according to an embodiment of the present invention may include an original image layer alignment unit 110, a 3D model layer generation unit 120, and a 3D model layer synthesis unit 130.

The original image layer alignment unit 110 may receive 2D original image layers for respective viewpoints and generate pieces of 2D original image information for respective objects by performing original image alignment on the 2D original image layers for respective viewpoints for each predefined object type.

Here, the original image layer alignment unit 110 may generate the pieces of 2D original image information for respective objects by performing the original image alignment on the 2D original image layers for respective viewpoints so that, depending on the predefined object types, multiple layers for respective viewpoints are included in at least one object type, wherein the 2D original image layers for respective viewpoints include multiple layers for respective object types for at least one viewpoint.

Here, the original image layer alignment unit 110 may generate calibration information corresponding to relative location relationships between the multiple layers for respective object types.

Referring to FIG. 2, the original image layer alignment unit 110 may receive 2D original image layers for respective v viewpoints, and each viewpoint may include n layers.

For example, the 2D original image layers for respective viewpoints may include 2D original image layers for two viewpoints, corresponding to the front and the side rotated relative to the front by an angle of 90°, or for three viewpoints, corresponding to the front, the side, and the back, or for more than three viewpoints.

Here, the original image layer alignment unit 110 may define the number of viewpoints and the number of layers.

For example, the number of viewpoints may be 2 (v=1) such that, for example, viewpoint_0 is a front image and viewpoint_1 is a side image.

The number of layers may be 6 (n=5), and objects may be defined for respective layers, as described below and shown in FIG. 2.

For example, layer 0 may correspond to a picture (image) of a torso, layer 1 may correspond to a picture of hair, layer 2 may correspond to a picture of an upper garment, layer 3 may correspond to a displacement map (a metadata layer) indicating wrinkles in the upper garment, layer 4 may correspond to a picture of a brooch, and layer 5 may correspond to a picture of pants.

Here, a 2D original image layer 100 from a front viewpoint may include six layers corresponding to layer 0 to layer 5.

Reference numeral 101 may be a picture of a torso from the front viewpoint, reference numeral 102 may be a picture of hair from the front viewpoint, and reference numeral 103 may be a picture of pants from the front viewpoint.

Here, the original image layer alignment unit 110 may also recognize an image generated by a commercial program supporting layers, such as Photoshop.

Here, the original image layer alignment unit 110 may provide a commercial program supporting layers, such as Photoshop, and receive an image to be input to each layer from the user, or may allow the user to personally draw a picture on each layer and input the corresponding image to the layer.

Here, the original image layer alignment unit 110 may generate calibration information including relative location relationships between the images that are input for respective layers.

For example, when drawing a brooch, if the brooch is drawn at a specific location on the layer corresponding to the upper garment, the calibration information may provide relative location relationships indicating the location at which the brooch is to be positioned relative to the location of the upper garment when 3D model layers for respective objects are synthesized based on the location of the brooch relative to the location of the upper garment.

Also, the original image layer alignment unit 110 may receive a 2D original image layer 200 from a side viewpoint.

For example, the 2D original image layer 200 from the side viewpoint may include a picture 201 of a torso from the side viewpoint, a picture 202 of hair from the side viewpoint, and a picture 203 of pants from the side viewpoint.

In this case, the 2D original image layer may include the above-described displacement map layer including information about wrinkles in clothes.

When a 3D object is produced, the wrinkles in clothes may be represented by geometry, or alternatively, a displacement map for the wrinkles may be created and shown.

In an application requiring real-time properties, baking of the actual 3D object may generally be performed using the displacement map.

Here, the displacement map may be baked together with 3D model layers for respective viewpoints when the 3D model layers for respective viewpoints are synthesized in a 3D model so as to represent wrinkles in the clothes.

The original image layer alignment unit 110 may align 2D original image layers for respective viewpoints as pieces of 2D original image information for respective objects through original image alignment.

Referring to FIG. 3, torso-object 2D original image information 300 may include torso object layers 301 from a front viewpoint and torso object layers 302 from a side viewpoint, and may further include torso object layers 303 from an additional viewpoint.

Pants-object 2D original image information 400 may include pants object layers 401 from a front viewpoint and pants object layers 402 from a side viewpoint, and may further include pants object layers 403 from an additional viewpoint.

The 3D model layer generation unit 120 may generate 3D model layers for respective objects from the pieces of 2D original image information for respective objects using multiple learning models corresponding to predefined object types.

Here, the 3D model layer generation unit 120 may infer 3D model layers for respective objects by inputting the pieces of 2D original image information for respective objects into the learning models.

For example, with regard to learning models, reference may be made to “3D Shape Reconstruction from Sketches via Multi-view Convolutional Networks” by Zhaoliang Lun, Matheus Gadelha, Evangelos Kalogerakis, Subhransu Maji, and Rui Wang, in arXiv 2017, 1707.06375.

The 3D model layer generation unit 120 may input pieces of 2D original image information for respective objects into learning models for respective objects, corresponding to the pieces of 2D original image information for respective objects, using pieces of metadata for respective layers.

Referring to FIG. 4, the 3D model layer generation unit 120 may input torso-object 2D original image information 300 into a torso-object learning model 500 and may input pants-object 2D original image information 400 into a pants-object learning model 501 by utilizing the pieces of metadata for respective layers.

Here, the pieces of metadata for respective layers may be as defined in the following Table 1.

TABLE 1

<?xml version=“1.0” encoding=“EUC-KR” ?>
<MetaInfos>
<Layer id=“0” property=“geo”>
<InferModel>ShapeMVD-1</InferModel>
<DirectCopy>NULL</DirectCopy>
</Layer>
<Layer id=“1” property=“geo”>
<InferModel>NULL</InferModel>
<DirectCopy>www.models.com/hair.obj</DirectCopy>
</Layer>
<Layer id=“2” property=“meta”>
<Type>DisplacementMap</Type>
</Layer>
</MetaInfos>

Referring to Table 1, the element “MetaInfos” may indicate the highest (top-level) element.

The element “Layer” may correspond to an element indicating information about each layer. In an example of the present invention, it can be seen that three elements are defined.

The attribute “id” may be represented by an integer that increases from 0 at an increment of 1.

The attribute “property” may indicate whether the corresponding layer indicates a picture containing appearance information or a metadata layer containing additional information. When the property indicates a metadata layer, it may include additional information, such as a displacement map or a normal map. When the value of the property indicates ‘geo’, the corresponding layer may be defined as a geometry layer, whereas when the value of the property is “meta”, the corresponding layer may be defined as a metadata layer.

The element “InferModel” defines an inference-learning model, which may be defined as a term designating a predefined learning model or may be a previously known learning model that is not standardized.

Here, when the element “InferModel” is defined as null, a model at a location defined in DirectCopy may be copied and used, without performing inference.

The element “DirectCopy” may correspond to an element indicating whether data is to be directly copied without performing inference. When DirectCopy is defined as null, data may be directly copied from the location (in the present example, ‘www.models.com/hair.obj’) defined as a value, without performing inference.

The element “Type” may be an element used only when the corresponding layer is a metadata layer, and may correspond to an element indicating which of metadata layers is to be used. The element “Type” may be predefined. The element “DisplacementMap” or “NormalMap” may define various 2D maps used in the field of computer graphics.

The 3D model layer generation unit 120 may generate 3D model layers for respective objects from the pieces of 2D original image information for respective objects using multiple learning models corresponding to predefined object types.

As illustrated in FIG. 4, it can be seen that the 3D model layer generation unit 120 reconstructs a torso-object 3D model layer 600 from the torso-object 2D original image information 300 through the torso-object learning model 500, and reconstructs a pants-object 3D model layer 601 from the pants-object 2D original image information 400 through a pants-object learning model 501.

The 3D model layer synthesis unit 130 may generate a 3D model by synthesizing the 3D model layers for respective objects.

Here, the 3D model layer synthesis unit 130 may generate the 3D model in consideration of the relative location relationships between 3D model layers for respective objects using the calibration information.

In this case, the 3D model layer synthesis unit 130 may transform the appearance of the 3D model by baking the 3D model using predefined displacement map information of the multiple layers for respective object types.

Referring to FIG. 4, it can be seen that the 3D model layer synthesis unit 130 generates a final 3D model 800 by synthesizing the torso-object 3D model layer 600 and the pants-object 3D model layer 601.

Here, the 3D model layer synthesis unit 130 may basically determine the relative locations of 3D objects in the 3D model layers for respective objects based on layer 0 (generally, a torso layer in the case of a human character).

Here, the 3D model layer synthesis unit 130 may generate a 3D model in consideration of the relative location relationships of the image input to the 3D model layers for respective objects using the calibration information.

For example, after a 3D torso object corresponding to layer 0 has been reconstructed, if a 3D pants object is reconstructed by layer 5, the 3D model layer synthesis unit 130 may recognize the relative locations of the reconstructed 3D model layers for respective objects in 3D space using the calibration information between the torso object layer 301 from the front viewpoint and the pants object layer 401 from the front viewpoint.

In this case, the 3D model layer synthesis unit 130 may recognize the location relationships between the 3D model layer_0 600 and the remaining generated 3D model layers 601 or the like using the calibration information, and may then generate the final 3D model by matching the 3D model layers in the same coordinate system.

Here, the additional information for rendering, such as the displacement map corresponding to the metadata layer, may be provided in the form of a 2D map, and may be baked, or may be defined in the form of shader code when 3D layers for respective objects are synthesized. The information defined in this way may be reflected in the final 3D model, or may be used when being rendered through an application service.

The configuration according to an embodiment of the present invention may be reconstructed in various manners without interfering with the characteristics of the present invention. For example, original image layers may be configured for respective body regions of each 3D object (arms, legs, face, clothes, etc.), and may be reconstructed and synthesized for respective body regions. Also, image layers may be inferred using two or more learning models generated in one layer, individual weights may be assigned to the generated 3D model layer 600, and two weighted models may be synthesized (for example, in such a way that respective object layers are inferred using an adult-type learning model and a child-type learning model and the results of the inference are averaged when a torso object layer is formed).

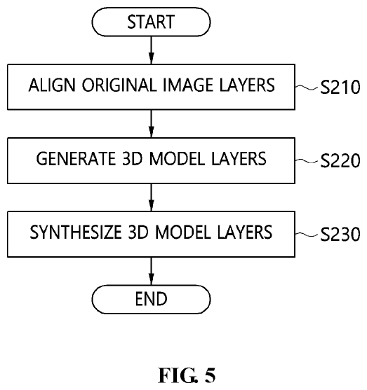

FIG. 5 is an operation flowchart illustrating a method for generating a 3D model according to an embodiment of the present invention.

Referring to FIG. 5, the 3D model generation method according to the embodiment of the present invention may align 2D original image layers for respective viewpoints at step S210.

That is, at step S210, 2D original image layers for respective viewpoints may be received, and pieces of 2D original image information for respective objects may be generated by performing original image alignment on the 2D original image layers for respective viewpoints for each predefined object type.

Here, at step S210, the pieces of 2D original image information for respective objects may be generated by performing the original image alignment on the 2D original image layers for respective viewpoints so that, depending on the predefined object types, multiple layers for respective viewpoints are included in at least one object type, wherein the 2D original image layers for respective viewpoints include multiple layers for respective object types for at least one viewpoint.

Here, at step S210, calibration information corresponding to relative location relationships between the multiple layers for respective object types may be generated.

Referring to FIG. 2, at step S210, 2D original image layers for respective v viewpoints may be received, and each viewpoint may include n layers.

For example, the 2D original image layers for respective viewpoints may include 2D original image layers for two viewpoints, corresponding to the front and the side rotated relative to the front by an angle of 90°, or for three viewpoints, corresponding to the front, the side, and the back, or for more than three viewpoints.

Here, at step S210, the number of viewpoints and the number of layers may be defined.

For example, the number of viewpoints may be 2 (v=1) such that, for example, viewpoint_0 is a front image and viewpoint_1 is a side image.

The number of layers may be 6 (n=5), and objects may be defined for respective layers, as described below and shown in FIG. 2.

For example, layer 0 may correspond to a picture (image) of a torso, layer 1 may correspond to a picture of hair, layer 2 may correspond to a picture of an upper garment, layer 3 may correspond to a displacement map (a metadata layer) indicating wrinkles in the upper garment, layer 4 may correspond to a picture of a brooch, and layer 5 may correspond to a picture of pants.

Here, a 2D original image layer 100 from a front viewpoint may include six layers corresponding to layer 0 to layer 5.

Reference numeral 101 may be a picture of a torso from the front viewpoint, reference numeral 102 may be a picture of hair from the front viewpoint, and reference numeral 103 may be a picture of pants from the front viewpoint.

Here, at step S210, an image generated by a commercial program supporting layers, such as Photoshop, may also be recognized.

Here, at step S210, a commercial program supporting layers, such as Photoshop, may be provided, and an image to be input to each layer may be received from the user, or alternatively, the user may be allowed to personally draw a picture on each layer and input the corresponding image to the layer.

Here, at step S210, calibration information including relative location relationships between the images that are input for respective layers may be generated.

For example, when drawing a brooch, if the brooch is drawn at a specific location on the layer corresponding to the upper garment, the calibration information may provide relative location relationships indicating the location at which the brooch is to be positioned relative to the location of the upper garment when 3D model layers for respective objects are synthesized based on the location of the brooch relative to the location of the upper garment.

Also, at step S210, a 2D original image layer 200 from a side viewpoint may be received.

For example, the 2D original image layer 200 from the side viewpoint may include a picture 201 of a torso from the side viewpoint, a picture 202 of hair from the side viewpoint, and a picture 203 of pants from the side viewpoint.

In this case, the 2D original image layer may include the above-described displacement map layer including information about wrinkles in clothes.

When a 3D object is produced, the wrinkles in clothes may be represented by geometry, or alternatively, a displacement map for the wrinkles may be created and shown.

In an application requiring real-time properties, baking of the actual 3D object may generally be performed using the displacement map.

Here, the displacement map may be baked together with 3D model layers for respective viewpoints when the 3D model layers for respective viewpoints are synthesized in a 3D model so as to represent wrinkles in the clothes.

At step S210, 2D original image layers for respective viewpoints may be aligned as pieces of 2D original image information for respective objects through original image alignment.

Referring to FIG. 3, torso-object 2D original image information 300 may include torso object layers 301 from a front viewpoint and torso object layers 302 from a side viewpoint, and may further include torso object layers 303 from an additional viewpoint.

Pants-object 2D original image information 400 may include pants object layers 401 from a front viewpoint and pants object layers 402 from a side viewpoint, and may further include pants object layers 403 from an additional viewpoint.

Next, the 3D model generation method according to the embodiment of the present invention may generate 3D model layers for respective objects at step S220.

That is, at step S220, 3D model layers for respective objects may be generated from the pieces of 2D original image information for respective objects using multiple learning models corresponding to predefined object types.

Here, at step S220, 3D model layers for respective objects may be inferred by inputting the pieces of 2D original image information for respective objects into the learning models.

For example, with regard to learning models, reference may be made to “3D Shape Reconstruction from Sketches via Multi-view Convolutional Networks” by Zhaoliang Lun, Matheus Gadelha, Evangelos Kalogerakis, Subhransu Maji, and Rui Wang, in arXiv 2017, 1707.06375.

Here, at step S220, pieces of 2D original image information for respective objects may be input into learning models for respective objects, corresponding to the pieces of 2D original image information for respective objects, using pieces of metadata for respective layers.

Referring to FIG. 4, at step S220, torso-object 2D original image information 300 may be input into a torso-object learning model 500, and pants-object 2D original image information 400 may be input into a pants-object learning model 501 by utilizing the pieces of metadata for respective layers.

Here, the pieces of metadata for respective layers may be as defined in Table 1.

Referring to Table 1, the element “MetaInfos” may indicate the highest (top-level) element.

The element “Layer” may correspond to an element indicating information about each layer. In an example of the present invention, it can be seen that three elements are defined.

The attribute “id” may be represented by an integer that increases from 0 at an increment of 1.

The attribute “property” may indicate whether the corresponding layer indicates a picture containing appearance information or a metadata layer containing additional information. When the property indicates a metadata layer, it may include additional information, such as a displacement map or a normal map. When the value of the property indicates ‘geo’, the corresponding layer may be defined as a geometry layer, whereas when the value of the property is “meta”, the corresponding layer may be defined as a metadata layer.

The element “InferModel” defines an inference-learning model, which may be defined as a term designating a predefined learning model or may be a previously known learning model that is not standardized.

Here, when the element “InferModel” is defined as null, a model at a location defined in DirectCopy may be copied and used, without performing inference.

The element “DirectCopy” may correspond to an element indicating whether data is to be directly copied without performing inference. When DirectCopy is defined as null, data may be directly copied from the location (in the present example, ‘www.models.com/hair.obj’) defined as a value, without performing inference.

The element “Type” may be an element used only when the corresponding layer is a metadata layer, and may correspond to an element indicating which of metadata layers is to be used. The element “Type” may be predefined. The element “DisplacementMap” or “NormalMap” may define various 2D maps used in the field of computer graphics.

Here, at step S220, 3D model layers for respective objects may be generated from the pieces of 2D original image information for respective objects using multiple learning models corresponding to predefined object types.

As illustrated in FIG. 4, at step S220, it can be seen that a torso-object 3D model layer 600 is reconstructed from the torso-object 2D original image information 300 through the torso-object learning model 500, and a pants-object 3D model layer 601 is reconstructed from the pants-object 2D original image information 400 through a pants-object learning model 501.

Further, the 3D model generation method according to the embodiment of the present invention may generate a 3D model by synthesizing the 3D model layers for respective objects at step S230.

Here, at step S230, the 3D model may be generated in consideration of the relative location relationships between 3D model layers for respective objects using the calibration information.

In this case, at step S230, the appearance of the 3D model may be transformed by baking the 3D model using predefined displacement map information of the multiple layers for respective object types.

Referring to FIG. 4, at step S230, it can be seen that a final 3D model 800 is generated by synthesizing the torso-object 3D model layer 600 and the pants-object 3D model layer 601.

Here, at step S230, the relative locations of 3D objects in the 3D model layers for respective objects may be basically determined based on layer 0 (generally, a torso layer in the case of a human character).

Here, at step S230, the 3D model may be generated in consideration of the relative location relationships of the image input to the 3D model layers for respective objects using the calibration information.

For example, at step S230, after a 3D torso object corresponding to layer 0 has been reconstructed, if a 3D pants object is reconstructed by layer 5, the relative locations of the reconstructed 3D model layers for respective objects in 3D space may be recognized using the calibration information between the torso object layer 301 from the front viewpoint and the pants object layer 401 from the front viewpoint.

In this case, at step S230, the location relationships between the 3D model layer_0 600 and the remaining generated 3D model layers 601 or the like may be recognized using the calibration information, and the final 3D model may be generated by matching the 3D model layers in the same coordinate system.

Here, the additional information for rendering, such as the displacement map corresponding to the metadata layer, may be provided in the form of a 2D map, and may be baked, or may be defined in the form of shader code when 3D layers for respective objects are synthesized. The information defined in this way may be reflected in the final 3D model, or may be used when being rendered through an application service.

The configuration according to an embodiment of the present invention may be reconstructed in various manners without interfering with the characteristics of the present invention. For example, original image layers may be configured for respective body regions of each 3D object (arms, legs, face, clothes, etc.), and may be reconstructed and synthesized for respective body regions. Also, image layers may be inferred using two or more learning models generated in one layer, individual weights may be assigned to the generated 3D model layer 600, and two weighted models may be synthesized (for example, in such a way that respective object layers are inferred using an adult-type learning model and a child-type learning model and the results of the inference are averaged when a torso object layer is formed).

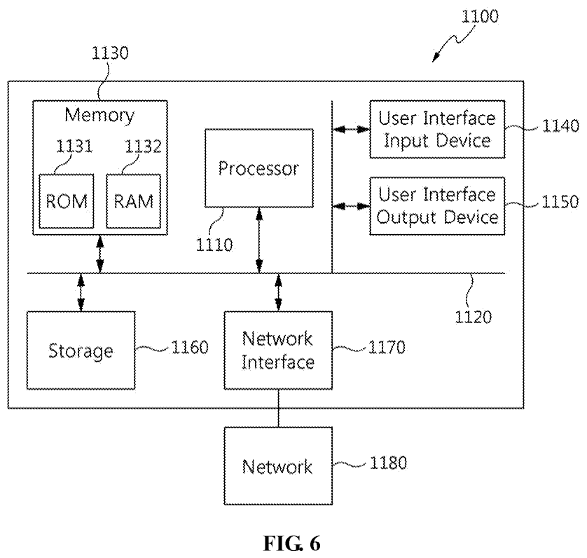

FIG. 6 is a diagram illustrating a computer system according to an embodiment of the present invention.

Referring to FIG. 6, an apparatus for generating a 3D model according to an embodiment of the present invention may be implemented in a computer system 1100, such as a computer-readable storage medium. As illustrated in FIG. 6, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

The 3D model generation apparatus according to an embodiment of the present invention may include one or more processors 1110 and execution memory 1130 for storing at least one program executed by the one or more processors 1110. The at least one program may be configured to receive two-dimensional (2D) original image layers for respective viewpoints, and generate pieces of 2D original image information for respective objects by performing original image alignment on the 2D original image layers for respective viewpoints for each predefined object type, generate 3D model layers for respective objects from the pieces of 2D original image information for respective objects using multiple learning models corresponding to the predefined object types, and generate a 3D model by synthesizing the 3D model layers for respective objects.

Here, the at least one program may be configured to generate the pieces of 2D original image information for respective objects by performing the original image alignment on the 2D original image layers for respective viewpoints so that, depending on the predefined object types, multiple layers for respective viewpoints are included in at least one object type, wherein the 2D original image layers for respective viewpoints include multiple layers for respective object types for at least one viewpoint.

Here, the at least one program may be configured to generate calibration information corresponding to relative location relationships between the multiple layers for respective object types.

Here, the at least one program may be configured to generate the 3D model in consideration of the relative location relationships between the 3D model layers for respective objects using the calibration information.

Here, the at least one program may be configured to transform an appearance of the 3D model by baking the 3D model using predefined displacement map information of the multiple layers for respective object types.

The present invention may generate a 3D model which is complicatedly configured based on various original images which cannot be provided by conventional technology.

Further, the present invention may accurately provide relative locations between objects and additional information of the objects when reconstructing a 3D model from a 2D image.

As described above, in the apparatus and method for generating a 3D model according to the present invention, the configurations and schemes in the above-described embodiments are not limitedly applied, and some or all of the above embodiments can be selectively combined and configured such that various modifications are possible

What is claimed is:

1. An apparatus for generating a three-dimensional (3D) model, comprising:
one or more processors; and
an execution memory for storing at least one program that is executed by the one or more processors,
wherein the at least one program is configured to:
receive two-dimensional (2D) original image layers for respective viewpoints, and generate pieces of 2D original image information for respective objects by performing original image alignment on the 2D original image layers for respective viewpoints for each predefined object type,
generate 3D model layers for respective objects from the pieces of 2D original image information for respective objects using multiple learning models corresponding to the predefined object types, and
generate a 3D model by synthesizing the 3D model layers for respective objects.

2. The apparatus of claim 1, wherein the at least one program is configured to generate the pieces of 2D original image information for respective objects by performing the original image alignment on the 2D original image layers for respective viewpoints so that, depending on the predefined object types, multiple layers for respective viewpoints are included in at least one object type, wherein the 2D original image layers for respective viewpoints include multiple layers for respective object types for at least one viewpoint.

3. The apparatus of claim 2, wherein the at least one program is configured to generate calibration information corresponding to relative location relationships between the multiple layers for respective object types.

4. The apparatus of claim 3, wherein the at least one program is configured to generate the 3D model in consideration of the relative location relationships between the 3D model layers for respective objects using the calibration information.

5. The apparatus of claim 4, wherein the at least one program is configured to transform an appearance of the 3D model by baking the 3D model using predefined displacement map information of the multiple layers for respective object types.

6. A method for generating a 3D model using a 3D model generation apparatus, the method comprising:
receiving two-dimensional (2D) original image layers for respective viewpoints, and generating pieces of 2D original image information for respective objects by performing original image alignment on the 2D original image layers for respective viewpoints for each predefined object type;
generating 3D model layers for respective objects from the pieces of 2D original image information for respective objects using multiple learning models corresponding to the predefined object types; and
generating a 3D model by synthesizing the 3D model layers for respective objects.

7. The method of claim 6, wherein generating the pieces of 2D original image information for respective objects is configured to generate the pieces of 2D original image information for respective objects by performing the original image alignment on the 2D original image layers for respective viewpoints so that, depending on the predefined object types, multiple layers for respective viewpoints are included in at least one object type, wherein the 2D original image layers for respective viewpoints include multiple layers for respective object types for at least one viewpoint.

8. The method of claim 7, wherein generating the pieces of 2D original image information for respective objects is configured to generate calibration information corresponding to relative location relationships between the multiple layers for respective object types.

9. The method of claim 8, wherein generating the 3D model is configured to generate the 3D model in consideration of the relative location relationships between the 3D model layers for respective objects using the calibration information.

10. The method of claim 9, wherein generating the 3D model is configured to transform an appearance of the 3D model by baking the 3D model using predefined displacement map information of the multiple layers for respective object types.
